(19) United States
(12) Patent Application Publication
(10) Pub. No.: US 2010/0198650 A1
(43) Pub. Date: Aug. 5, 2010

(54) Method of providing game tracking data

(76) Inventor: Mark Shaw, Pone Vedra Beach, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/657,532

(22) Filed: Jan. 22, 2010

Related U.S. Application Data
(60) Provisional application No. 61/205,826, filed on Jan. 23, 2009.

(51) Int. Cl. G06Q 50/00; G06Q 10/00; G06Q 30/00; G06Q 99/00; G06F 17/30; H04L 9/32; G06Q 20/00; G08B 1/08

(52) U.S. Cl. 705/9; 705/307; 705/310; 707/722; 713/170; 340/539.13; 707/786; 707/E17.018; 707/E17.044

(57) ABSTRACT

A method for tracking game comprising the steps of fixing tracking devices to the game, receiving data transmitted by the tracking devices, storing the data in the database, providing the web page as a user interface, registering users through the web page, issuing user credentials to authenticate users, and displaying information via the web page. The tracking devices can be configured to gather and to transmit a variety of data, such as weather or water conditions, location, species of game, and many others. Data is processed and stored according to categories of information contained therein. The user accesses the stored data by a web page, which can be configured to display certain categories of data, to provide access to certain electronic features, or to provide certain features corresponding to a user-selected membership level.

This application claims the benefit of U.S. Provisional Patent Application Ser. No. 61/205,826, filed on Jan. 23, 2009.

### BACKGROUND OF THE INVENTION

Recent technology has enabled electronic tracking of many types of objects, such as vehicles, packages, animals or people. This tracking technology uses data transmission systems such as radar, sonar, global positioning systems or the like. In recent years some of these systems have been adapted to accommodate tracking of game, such as animals, birds and fish. However, these systems have been complex, difficult to implement, and expensive to operate. In some instances, the tracking systems require specialized equipment to receive the data or to convert it into a useable form. As a result, the data gathered by these tracking systems has been largely inaccessible by individuals who could benefit from the data.

The present invention seeks to provide a method of tracking game such that an end user can access a web site to retrieve data corresponding to certain game in certain geographic locations.

### SUMMARY OF THE INVENTION

The method and process of game tracking uses a system for tracking objects. Several such systems exist and are adapted for tracking objects such as trucks, boats, packages, or people. These systems can be adapted for a specific use or to gather specific data about game, such as animals, birds, and fish. Additionally, these systems can be programmed to measure, collect, and transmit certain types of data, such as the movement of a certain animal species or data about weather conditions, marine conditions, water temperatures, and many other categories of information. Examples of such systems include U.S. Pat. Nos. 7,218,227, 7,391,365, and 6,163,503, and U.S. Patent Application Publication No. 2002/0021219, the specifications of which are incorporated herein by this reference.

In one embodiment, the method of game tracking comprises the steps of fixing tracking devices to the game, receiving data transmitted by the tracking devices, storing the data in a database, providing a web page as a user interface, registering users via the web page, issuing user credentials to authenticate users, and displaying information via the web page. The step of fixing tracking devices can be accomplished directly by the system operator or by local agents, such as hunting or fishing guides or commercial fishermen. In the step of receiving data, the tracking devices are programmed to transmit certain types of data at desired time intervals, or real-time by continuous transmissions. In the step of data storage, data transmitted by the tracking devices is received and interpreted, processed or categorized as needed or desired.

In the step of providing the web page as a user interface, the web page is adapted to accommodate user preferences, such as displaying certain types of data, displaying blogs, or accessing chat rooms or discussion forums. The step of user registration comprises the steps of receiving user information and the step of issuing credentials unique to the user. Optionally, the step of user registration can further comprise the step of establishing one or more membership levels. When a user becomes a member, the user selects the desired membership level to attain access to the desired package of features. In the step of issuing user credentials, the credentials correspond to the user-selected membership level. Finally, in the step of displaying information, the user accesses the web site with the user's credentials, and the web site displays the data and information corresponding to the credentials.

In another embodiment, the method of game tracking further comprises the step of issuing tracking devices to the user, and during this step the system operator issues a one or more tracking devices to a user having unique credentials, and the user then attaches the tracking devices to the game of the user's choice. Then, in the step of storing data, the data received from these emitters is categorized into user-specific storage categories and stored in the database by the corresponding user credentials such that only the user having matching credentials can access the data received from the issued tracking devices.

The business process corresponding to the method of tracking game comprises the additional steps of compensating the local agents, receiving a membership subscription fee, receiving a user fee, and offering a reward for retrieved tracking devices. The step of agent compensation occurs during the step of fixing tracking devices, and the compensation can correspond to the number of devices fixed or the number of times end users access data emitted from the tracking device.

The step of receiving a membership subscription fee occurs during the step of user registration. The subscription fee can correspond to a certain membership level or periodic access to certain features, such as real-time game tracking features. The step of receiving a user fee can occur at any time after user registration. Finally, the step of offering a reward for retrieved tracking devices is not limited to users of the system. The system operator could offer such a reward to any individual redeeming used tracking devices.

### BRIEF DESCRIPTION OF THE DRAWINGS

FIG. 1 is an schematic showing the interrelation of the components of a typical tracking system.

FIG. 2 is flowchart showing the fundamental steps of the method of tracking game.

FIG. 3 is the flowchart of FIG. 2 showing the optional step of establishing membership levels.

FIG. 4 is the flowchart of FIG. 3 showing the optional step of issuing tracking devices.

FIG. 5 is a flowchart showing the additional steps for the business process.

### DETAILED DESCRIPTION OF THE INVENTION

With reference to the drawings, the invention will now be described with regard for the best mode and the preferred embodiment. In general, the invention is method and business process for tracking fish and game via a global communication system. The embodiments disclosed herein are meant for illustration and not limitation of the invention. An ordinary practitioner will understand that it is possible to create many variations of the following embodiments without undue experimentation.

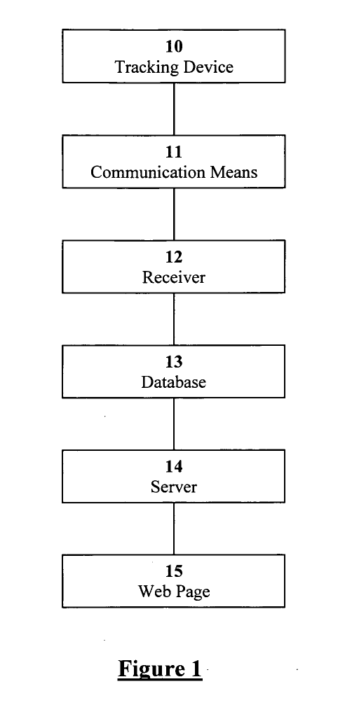

The method described herein uses a suitable known system 1 for tracking objects, such as trucks, boats, packages, or people. Many such tracking systems operate using a global positioning system (“GPS”) or other technology. Referring to FIG. 1, these systems 1 comprise fundamental elements, such as a tracking device 10 affixed to an object of interest, communication means 11 for interchanging data between the tracking device 10 and a receiver 12, a database 13 for storing data received from the tracking device 10, and a server 14 that supports a graphical user interface 15, such as a web page. At the user's option, these systems can comprise additional features, such as encryption technology securing data transmitted between the tracking device 10 and receiver 12, or security features protecting the server 14 and web site 15 from unauthorized access.

An ordinary practitioner will understand that the tracking device 10 can be adapted for a specific use or to gather specific data. For example, the tracking device 10 can be sized or shaped to accommodate certain animals or fish. Additionally, the tracking device 10 can be programmed to measure, collect, and transmit certain types of data, such as the movement of a certain animal species or data about weather conditions, marine conditions, water temperatures, and many other categories of information. The communication means 11 is any suitable known means for communication between the tracking device 10 and the receiver 12. The communication means 11 is selected and adapted according to the specific application and requirements. For example, the communication means 11 could be radar, sonar, GPS, radio or other types of communication means, including a combination of two or more of these means. In the preferred application of the system 1, the graphical user interface 15 is a web page.

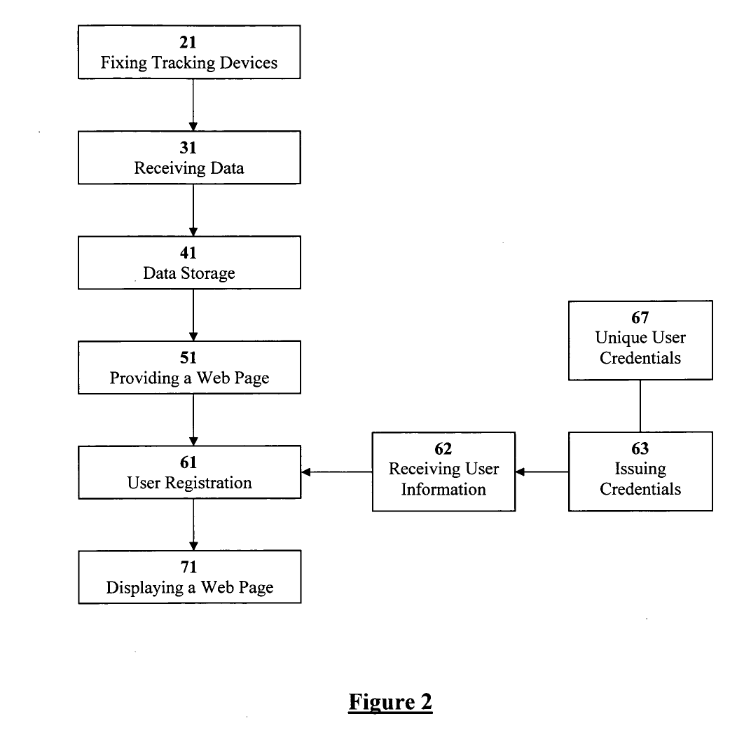

The foregoing system 1 can be adapted by a system operator to track many types of land-dwelling or sea-dwelling game, such as animals, birds or fish. Referring to FIG. 2, the method of game tracking comprises the steps of fixing tracking devices to the game 21, receiving data transmitted by the tracking devices 31, storing the data in the database 41, providing the web page as a user interface 51, registering users via the web page 61, and displaying information via the web page pursuant to the user's credentials 71.

The step of fixing tracking devices 21 can be accomplished directly by the system operator. In applications where the game tracking system spans a large geographical area, the system operator can retain local agents, such as hunting or fishing guides or commercial fishermen, to fix tracking devices 10 to game. Fewer tracking devices 10 are needed for game that typically congregates in herds, packs, or schools. In the step of receiving data 31, the tracking devices 10 are adapted to gather certain types of desirable data, such as location, weather conditions, water conditions, or the like. Also, the tracking devices 10 can be programmed or adapted to transmit data at desired time intervals or real-time by continuous transmissions. In the step of storing data 41, data received from the tracking devices 10 is received, interpreted, processed or categorized as needed or desired. For example, data could be categorized according to the species or location of game, or the date that the data was recorded. Data processing can be accomplished before or after the data is stored in the database 13.

In the step of providing the web page as a user interface 51, the web page 15 is configured to retrieve data from the database 13 on the server 14. Transmissions between the web page 15 and server 14 can be encrypted, such as by hypertext transfer protocol secure (HTTPS) transmissions. The web page 15 is adapted to accommodate specific uses, such as displaying blogs or accessing chat rooms or discussion forums. The web page 15 could also be configured to display certain categories of data, such as location of a species or the weather conditions in a certain geographic location, or other desired information stored in the database 13. The web page 15 could also be configured to display certain features or a package of features corresponding to a certain membership level, as discussed below. The web page 15 can be displayed by a communication medium or network such as the Internet or an intranet system.

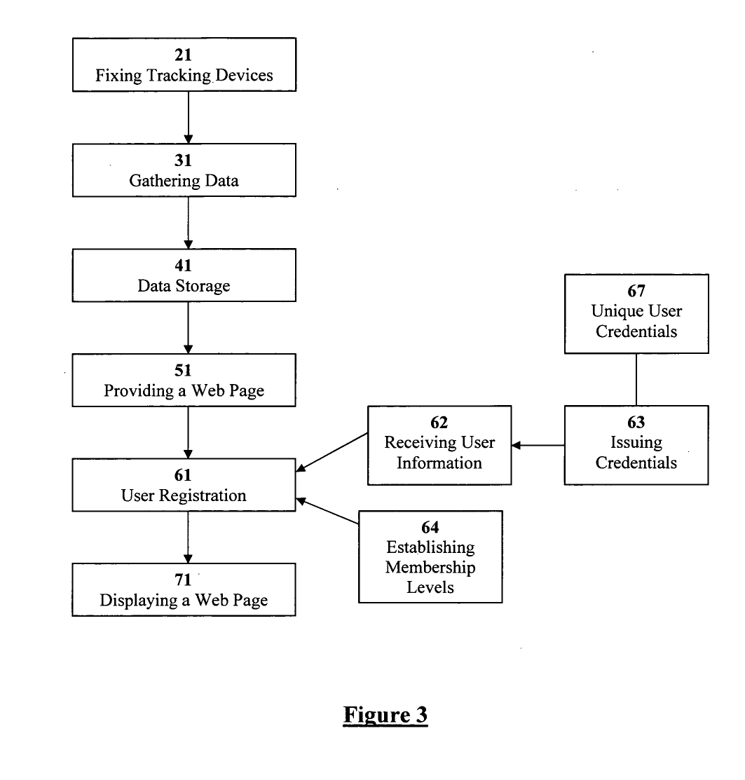

The step of user registration 61 comprises the steps of receiving user information 62 such as name, address, or the like, and the step of issuing user credentials 63, such as a username, password, or other codes. Each user should receive unique credentials 67. Optionally, as in FIG. 3, the step of user registration 61 can further comprise the step of establishing one or more membership levels 64, such as basic membership or preferred membership. In this embodiment, a certain package of features is established for each level of membership. Such features may include species-specific data, access to real-time data, or access to enhanced features of the web site 14, such as chat rooms, blogs, message boards, or automatic notifications concerning data selected by the user. Automatic notifications, for example, could be an automatic electronic mail message, electronic page, SMS text message, or the like regarding a certain species of game being tracked or game movement within a certain geographic area. When a user becomes a member, the user selects the desired membership level to attain access to the desired package of features. In the step of issuing user credentials 63, the credentials 67 correlate to the user-selected membership level and user preferences. Finally, in the step of displaying information 71, the user accesses the web site 15 with the user's credentials 67, and the web site 14 displays the data and information corresponding to the credentials 67. For example, depending on the credentials 67, the web page 15 may display a configuration corresponding to the user's membership level or preferences.

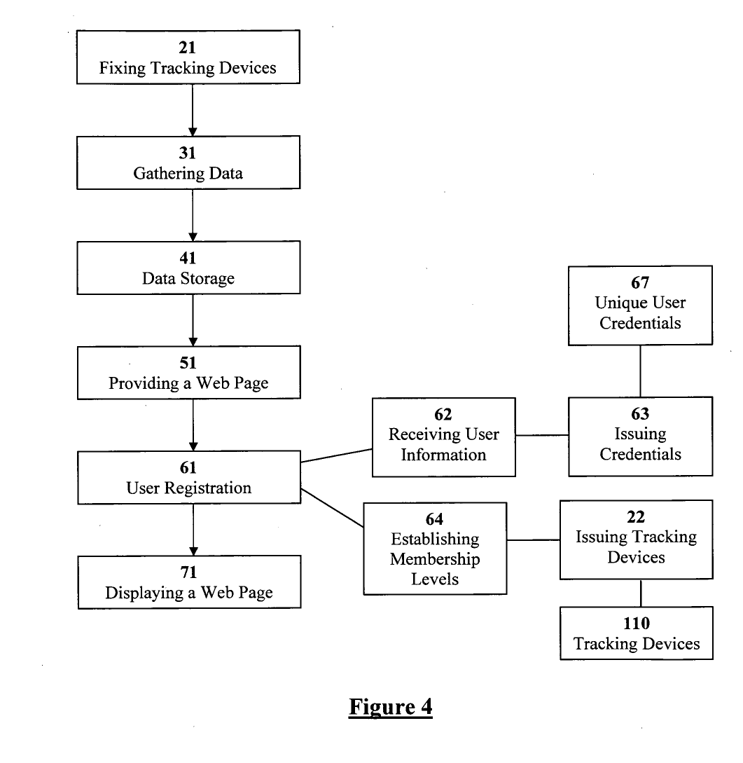

Referring to FIG. 4, another embodiment of the method of game tracking further comprises the step of issuing tracking devices 22 to the user. This step can occur any time after the step of user registration 61. In the step of issuing tracking devices 22, the system operator issues a one or more tracking devices 110 to a user having certain credentials 67, and the user then attaches the tracking devices 110 to the game of the user's choice. Then, in the step of storing data 41, the data received from these emitters is categorized and stored in the database 13 by the corresponding user credentials 67 such that only the user having matching credentials 67 can access the data received from the issued tracking devices 110. When the user accesses his or her membership package with his or her credentials 67, the user has access to the data received from the tracking devices 110 that the user fixed to the desired game. As another option, the system operator could pay the user a commission if the user opens this data for access by other users.

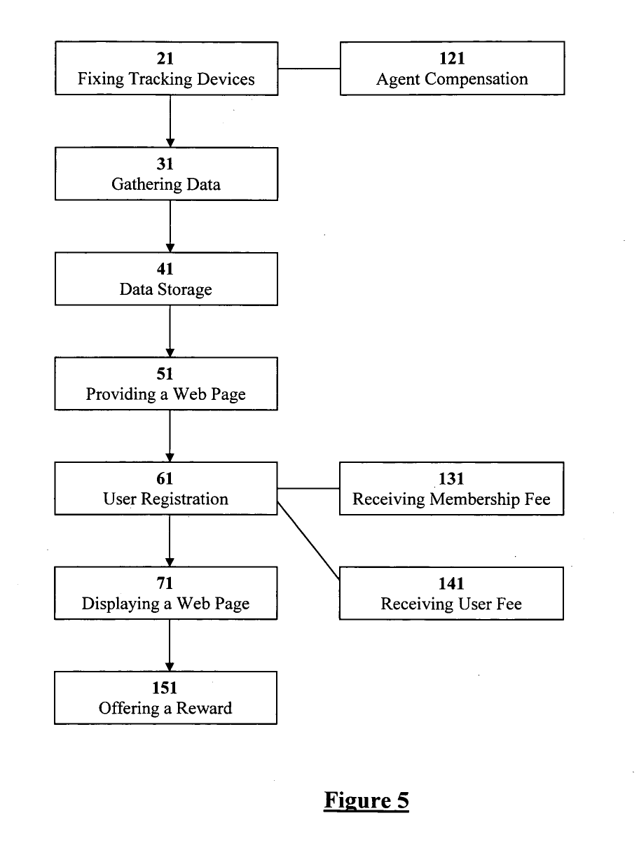

Referring to FIG. 5, the business process corresponding to the method of tracking game comprises the additional steps of compensating the local agents 121, receiving a membership subscription fee 131, receiving a user fee 141, and offering a reward for retrieved tracking devices 151. The step of agent compensation 121 occurs during the step of fixing tracking devices 21. Agent compensation 121 applies when the system operator engages local agents to affix tracking devices 10 to game, and the compensation can correspond to the number of devices fixed or the number of times end users access data emitted from the tracking device 10.

The step of receiving a membership subscription fee 131 occurs during the step of user registration 61. During registration, the user makes the required subscription payment through the web site 15. The subscription fee can correspond to a certain membership level or periodic access to certain features, such as real-time game tracking features. The step of receiving a user fee 141 can occur at any time after user registration 61. In this context, a user fee is a charge relating to a specific allotment of goods or services. For example, the user could be charged a fee to receive tracking devices 110 to affix to local game, as described above. Finally, the step of offering a reward for retrieved tracking devices 151 is not limited to users of the system. The system operator could offer such a reward to any individual redeeming used tracking devices 10.

The foregoing embodiments are merely representative of the system and methods and not meant for limitation of the invention. For example, one having ordinary skill in the art would understand that the method of tracking described herein has many steps and components that can be customized for specific applications by one having ordinary skill in the art. Consequently, it is understood that equivalents and substitutions for certain elements, components, and steps set forth above are part of the invention, and therefore the true scope and definition of the invention is to be as set forth in the following claims.

I claim:

1. A method for providing data relating to game, wherein the data is provided and displayed via a global communication system according to pre-selected membership levels, the method comprising the steps of:
receiving an electronic transmission of data transmitted via a communication means from a tracking device affixed to game, wherein the data is selected from the group consisting of weather conditions, marine conditions, the location of the game, the species of game, the history of the game's movement, and the location of nearby game, and wherein the communication means is selected from the group consisting of radar, sonar, GPS, and radio communication systems;
storing said data on a database wherein the data is organized by pre-selected categories of data;
providing a graphical user interface comprising features relating to game, said features selected from the group consisting of bulletin boards, blogs, chat rooms, discussion forums, newsletters, news releases, and automatic notifications;
registering users by receiving user information and issuing unique credentials to the user corresponding to said user information, wherein said user information is selected from the group consisting of the user's name, address, age, location, and payment information, and wherein said unique credentials are selected from the group consisting of a username, a password, a digital signature, and a digital certificate;
establishing one or more membership levels comprising a pre-selected combination of data categories or features;
associating the user's unique credentials with a membership level; and
displaying via the graphical user interface the data or features corresponding to the membership level associated with the user's unique credentials.

2. The method of claim 1, additionally comprising the step of affixing the tracking device to game.

3. The method of claim 2, additionally comprising the step of issuing tracking devices to the user for the user to affix to game of the user's choice.

4. The method of claim 3, additionally comprising the steps of creating a user-specific data storage category corresponding to a user's unique credentials, storing in the user-specific storage category the data received from tracking devices affixed to game by the user, and displaying data in said user-specific storage category in response to a request by the user.

5. The method of claim 4, additionally comprising the step of providing to the user the option to display to other members the data from said user's user-specific storage category.

6. The method of claim 5, wherein the automatic notifications are selected from the group consisting of electronic mail, SMS text messages, voicemail, and electronic page.

7. The method of claim 6, wherein the step of displaying data or features comprises real-time display of data transmitted from a tracking device.

8. The method of claim 7, wherein the electronic transmission of data comprises the transmission of encrypted data.

9. The method of claim 8, wherein the step of providing a graphical user interface additionally comprises the step of providing a secure transmission medium for the graphical user interface.

10. The method of claim 1, additionally comprising the step of engaging local agents to affix the tracking devices to the game.

11. The method of claim 10, additionally comprising the step of engaging agents to retrieve tracking devices.

12. The method of claim 1, additionally comprising the step of issuing compensation for the return of tracking devices.

13. In a method for providing data relating to game tracking, wherein the data is provided and displayed via a global communication system, the improvement comprising the steps of:
utilizing a global positioning system to collect data relating to game tracking;
storing said data on a database wherein the data is organized by pre-selected categories of data;
providing a graphical user interface comprising features relating to game, said features selected from the group consisting of bulletin boards, blogs, chat rooms, discussion forums, newsletters, news releases, and automatic notifications;
establishing one or more membership levels comprising a pre-selected combination of data categories or features;
registering users by receiving user information and issuing unique credentials to the user corresponding to said user information, wherein said user information is selected from the group consisting of the user's name, address, age, location, and payment information, and wherein said unique credentials are selected from the group consisting of a username, a password, a digital signature, and a digital certificate;
associating the user's unique credentials with a membership level; and
displaying via the graphical user interface the data or features corresponding to the membership level associated with the user's unique credentials.

14. The method of claim 13, additionally comprising the steps of creating a user-specific data storage category corresponding to a user's unique credentials, storing in the user-specific storage category the data received from tracking devices affixed to game by the user, and displaying data in said user-specific storage category in response to a request by the user.

15. The method of claim 14, additionally comprising the step of providing to the user the option to display to other members the data from said user's user-specific storage category.

16. The method of claim 15, wherein the step of displaying data or features comprises real-time display of data transmitted from a tracking device.

17. The method of claim 16, wherein the electronic transmission of data comprises the transmission of encrypted data.

18. The method of claim 17, wherein the step of providing a graphical user interface additionally comprises the step of providing a secure transmission medium for the graphical user interface.

19. The method of claim 16, additionally comprising the step of engaging agents to retrieve tracking devices.

20. The method of claim 19, additionally comprising the step of issuing compensation for the return of tracking devices.
